(19) United States
(12) Patent Application Publication
(10) Pub. No.: US 2014/0176809 A1
(43) Pub. Date: Jun. 26, 2014

(54) RING-TYPE REMOTE CONTROL DEVICE, SCALING CONTROL METHOD AND TAP CONTROL METHOD THEREOF

(71) Applicant: ASKEY COMPUTER CORP, NEW TAIPEI CITY (TW)

(72) Inventor: Wei-Yu Chen, Taipei City (TW)

(21) Appl. No.: 13/929,803

(22) Filed: Jun. 28, 2013

(30) Foreign Application Priority Data
Dec. 25, 2012 (TW) 101149887

(51) Int. Cl. H04N 5/44

(52) U.S. Cl. CPC H04N 5/4403
USPC 348/734

(57) ABSTRACT

A ring-type remote control device, a scaling control method and a tap control method are provided. The ring-type remote control device includes a processing unit, a wireless communication module, a motion sensor module and a proximity sensor. The motion sensor module detects position information of the ring-type remote control device. The proximity sensor detects a distance variation between the first and second fingers of a user. When the processing unit determines the distance decreases according to the position information and the distance information, a reduced signal is generated and transferred to the wireless communication module. When the processing unit determines the distance increases, an enlarged signal is generated and transferred to the wireless communication module. The wireless communication module transmits a command corresponding to the reduced signal or the enlarged signal to an interactive receiving device, so as to generate an interactive operation.

### CROSS-REFERENCE TO RELATED APPLICATION

This application claims the priority benefit of Taiwan application serial no. 101149887, filed on Dec. 25, 2012. The entirety of the above-mentioned patent application is hereby incorporated by reference herein and made a part of this specification.

### BACKGROUND

1. Field of the Invention

The invention relates to a remote control device and a control method thereof, and more particularly, to a ring-type remote control device and a control method thereof.

2. Description of Related Art

Smart TVs, or Internet Protocol Televisions (IPTVs), which have access to the Internet have gradually emerged in the market and provide users with more and more diverse usage scenarios. For example, the users are provided with multimedia-on-demand (MOD) or video-on-demand (VOD), etc.

However, most of the current smart TVs allow the users to operate the TVs only through remote controls. Current remote controls usually have only input keys like directional keys of up, down, left and right and numeric keys. As the usage scenarios become diversified, it is very inconvenient for the users to perform selection, operation and input through the current remote controls. In particular, when connected to the Internet, the users often have to perform operations like enlargement, reduction, tapping and dragging when operating a menu and browsing web pages. The current remote controls are unable to issue the above commands in a simple way.

There is another way to control the smart TVs through voice control or gesture operation, and this way requires an audio capture or video capture hardware devices to be disposed on the smart TVs. There is still room for improvement for the correct recognition rate of the voice control, and using the video capture apparatus to recognize the gesture operation is limited by the effective shooting range of the video capture apparatus. Furthermore, when several people watch the smart TV at the same time, mutual interference in the current voice control or gesture operation is likely to occur and leads to incorrect recognition. Therefore, it is necessary to provide a more simple and convenient way to perform input control operations on the smart TVs to meet the diversified usage scenarios.

### SUMMARY OF THE INVENTION

In light of the above, the invention is directed to a ring-type remote control device and a control method thereof which allow users to intuitively and quickly perform input control operations such as enlargement, reduction or tapping to a smart TV by wearing the ring-type remote control device.

The invention provides a ring-type remote control device adapted to be disposed surrounding a finger of a user. The ring-type remote control device includes a processing unit, a wireless communication module, a motion sensor module and a first proximity sensor. The wireless communication module is coupled to the processing unit. The motion sensor module is coupled to the processing unit to detect position information of the ring-type remote control device. The first proximity sensor is coupled to the processing unit to detect distance information between a first finger and a second finger of the user. When the processing unit determines a distance between the first finger and the second finger decreases according to the position information and the distance information, a reduced signal is generated and transferred to the wireless communication module. When the processing unit determines the distance between the first finger and the second finger increases, an enlarged signal is generated and transferred to the wireless communication module. The wireless communication module transmits a command corresponding to the reduced signal or the enlarged signal to an interactive receiving device.

In an embodiment of the invention, the motion sensor module includes an accelerometer and a gyro sensor. The accelerometer detects an acceleration of the ring-type remote control device, and the gyro sensor detects an angular velocity of the ring-type remote control device. The motion sensor module generates position information according to the detected acceleration and the detected angular velocity.

In an embodiment of the invention, the processing unit determines whether the ring-type remote control device is in a horizontal state, a vertical state or an oblique state according to the position information. When the ring-type remote control device is in the horizontal state, the processing unit decides whether to generate a horizontal reduced signal or a horizontal enlarged signal according to the distance information. When the ring-type remote control device is in the vertical state, the processing unit decides whether to generate a vertical reduced signal or a vertical enlarged signal according to the distance information. When the ring-type remote control device is in the oblique state, the processing unit decides whether to generate an oblique reduced signal or an oblique enlarged signal according to the distance information.

In an embodiment of the invention, when the processing unit determines a time for which the distance between the first finger and the second finger remains at a fixed value exceeds a predetermined period of time according to the distance information, the processing unit further generates a first control signal to the wireless communication module.

In an embodiment of the invention, when the processing unit determines according to the distance information that the distance between the first finger and the second finger remains at a fixed value, and that the ring-type remote control device keeps moving, the processing unit further generates a second control signal to the wireless communication module.

In an embodiment of the invention, the ring-type remote control device further includes a second proximity sensor coupled to the processing unit. The processing unit generates a first, a second and a third states by controlling enables and disables of the first and second proximity sensors, and the processing unit generates corresponding state control signals corresponding to each of the states respectively.

The invention further provides a scaling control method for a ring-type remote control device, wherein the ring-type remote control device is disposed surrounding a finger of a user. The control method includes the following steps. Position information of the ring-type remote control device is detected first, and then distance information between a first finger and a second finger of the user is detected. A distance variation between the first finger and the second finger is determined according to the position information and the distance information. When the distance between the first finger and the second finger decreases, the ring-type remote control device generates a reduced signal; when the distance between the first finger and the second finger increases, the ring-type remote control device generates an enlarged signal. In addition, the ring-type remote control device transmits to an interactive receiving device a reduced command or an enlarged command respectively corresponding to the reduced signal or the enlarged signal so as to control the interactive receiving device to reduce or enlarge an object correspondingly.

The invention further provides a tap control method for a ring-type remote control device, wherein the ring-type remote control device is disposed surrounding a finger of a user. The tap control method includes the following steps. Position information of the ring-type remote control device is detected first, and then a rotation angle of the ring-type remote control device is detected. It is determined whether the rotation angle is greater than a predetermined rotation angle; if yes, the ring-type remote control device generates a tap signal. In addition, the ring-type remote control device transmits a tap command corresponding to the tap signal to an interactive receiving device so as to control the interactive receiving device to select an object.

Based on the above, the ring-type remote control device and the control method thereof provided by the invention are able to perform operations, such as enlargement and reduction, on the object displayed by the interactive receiving device by using the motion sensor module and the proximity sensors.

In order to make the aforementioned features and advantages of the present invention more comprehensible, embodiments accompanied with figures are described in detail below.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIG. 1 is a block diagram of a ring-type remote control device according to an embodiment of the invention.

FIG. 2 is a schematic diagram of an application scenario of a ring-type remote control device according to an embodiment of the invention.

FIG. 3 is a flow chart of a scaling control method according to an embodiment of the invention.

FIG. 4 is a flow chart of another scaling control method according to an embodiment of the invention.

FIG. 5 is a schematic diagram of an application scenario of a ring-type remote control device according to an embodiment of the invention.

FIG. 6 is a block diagram of a ring-type remote control device according to another embodiment of the invention.

FIG. 7 is a flow chart of a tap control method according to another embodiment of the invention.

### DESCRIPTION OF EMBODIMENTS

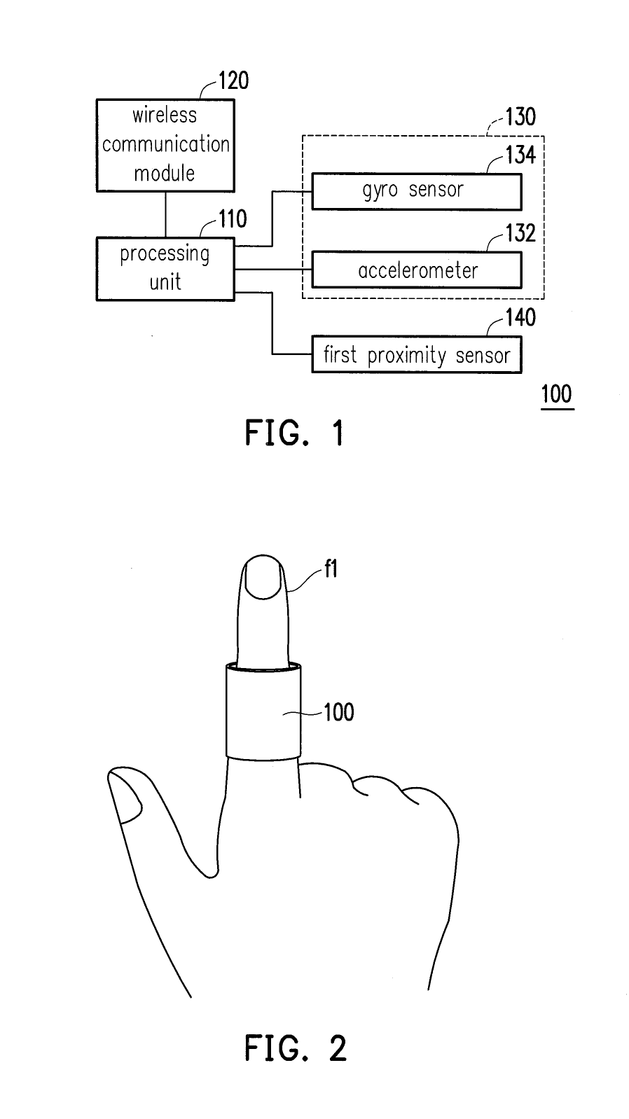

FIG. 1 is a block diagram of a ring-type remote control device according to an embodiment of the invention. FIG. 2 is a schematic diagram of an application scenario of a ring-type remote control device according to an embodiment of the invention. Referring to FIGS. 1 and 2, a ring-type remote control device 100 of the present embodiment is adapted to be disposed surrounding a finger of a user. In the present embodiment, the ring-type remote control device 100 is disposed surrounding an index finger f1 of the user, for example, but the invention is not limited thereto.

The ring-type remote control device 100 includes a processing unit 110, a wireless communication module 120, a motion sensor module 130 and a first proximity sensor 140, and functions thereof are illustrated below.

The processing unit 110 is, for example, a central processing unit (CPU) or a microprocessor, a digital signal processor (DSP) and a micro-controller unit (MCU) that are programmable for general or specific uses. The processing unit 110 receives detection signals from the motion sensor module 130 and the first proximity sensor 140 and transmits commands to be transmitted to the wireless communication module 120.

The wireless communication module 120 is any one of a radio frequency (RF) module, a Bluetooth module and a wireless fidelity (Wi-Fi) module, for example, but is not limited thereto. The wireless communication module 120 transmits a command transmitted by the processing unit 110 to an interactive receiving device (not shown). The interactive receiving device is, for example, a smart TV or other electronic devices with display and wireless reception capabilities, which is not limited herein.

The motion sensor module 130 includes an accelerometer 132 and a gyro sensor 134. The accelerometer 132 detects a translational acceleration or an impact of the ring-type remote control device 100. The gyro sensor 134 detects a rotational angular velocity of the ring-type remote control device 100. The motion sensor module 130 generates different control signals according to a difference between the acceleration and the angular velocity and generates position information of the ring-type remote control device 100 accordingly. It should be noted that the motion sensor module 130 is also able to recognize a double click function of the ring-type remote control device 100 so as to generate a corresponding control signal.

The first proximity sensor 140 is a means capable of detecting an object approaching. Types of a proximity sensor include inductive, capacitive, photoelectric and microwave sensors, which is not limited herein. The proximity sensor is sensitive to an approaching object and is thus able to recognize the approach of the object and output a corresponding signal. In the present embodiment, the ring-type remote control device 100 is, for example, disposed surrounding the index finger f1 of the user. Therefore, the first proximity sensor 140 is, for example, set as having a function of detecting if the thumb or the middle finger of the user approaches the index finger f1.

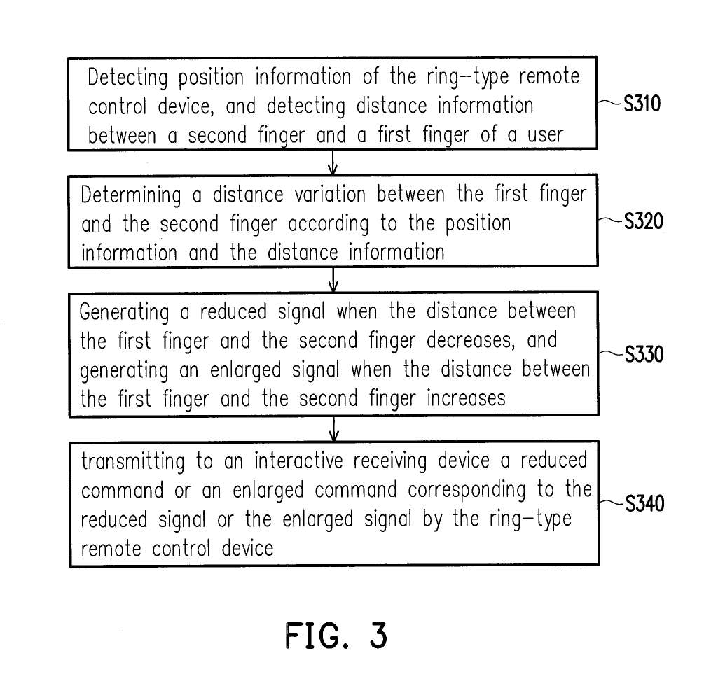

FIG. 3 is a flow chart of a scaling control method according to an embodiment of the invention. The method of the present embodiment is applicable for the ring-type remote control device 100 of FIG. 1. In the present embodiment, it is presumed that the ring-type remote control device 100 is disposed surrounding the index finger f1 of the user (as shown in FIG. 2). Detailed steps of the method of the present embodiment are elaborated below with reference to each element of the ring-type remote control device 100.

First, in Step S310, the motion sensor module 130 detects position information of the ring-type remote control device 100, and the processing unit 110 determines positioning level and movement states of the ring-type remote control device 100 according to the position information. In addition, the first proximity sensor 140 detects distance information between a second finger and a first finger of the user. In the present embodiment, the first finger refers to an index finger f1 of the user, and the second finger refers to a thumb or a middle finger of the user.

In Step S320, the processing unit 110 determines a distance variation between the first finger and the second finger with reference to both the position information and the distance information.

Since the first proximity sensor 140 is only able to detect an object within a certain distance, the detection scope depends on the sensing capability of the first proximity sensor 140. Therefore, in Step S330, if the first proximity sensor 140 detects that a distance between the first finger and the second finger decreases, the first proximity sensor 140 generates a reduced signal correspondingly to the processing unit 110. On the contrary, if the first proximity sensor 140 detects that the distance between the first finger and the second finger increases, the first proximity sensor 140 generates an enlarged signal correspondingly to the processing unit 110.

In Step S340, the processing unit 110 determines what command to generate to the wireless communication device 120 according to the received signal. In detail, if the processing unit 110 receives the reduced signal, the processing unit 110 issues a corresponding reduced command to the wireless communication device 120, so that the wireless communication device 120 transmits data of the reduced command to the interactive receiving device to control the interactive receiving device to reduce a corresponding object on display. Similarly, if the processing unit 110 receives the enlarged signal, the processing unit 110 issues a corresponding enlarged command to the wireless communication device 120, so that the wireless communication device 120 transmits data of the enlarged command to the interactive receiving device to control the interactive receiving device to enlarge a corresponding object on display.

Based on the above, by wearing the ring-type remote control device 100, the user is able to enlarge or reduce the object easily through a distance variation between the index finger and the thumb (or between the index finger and the middle finger), which is quite intuitive and convenient for the user.

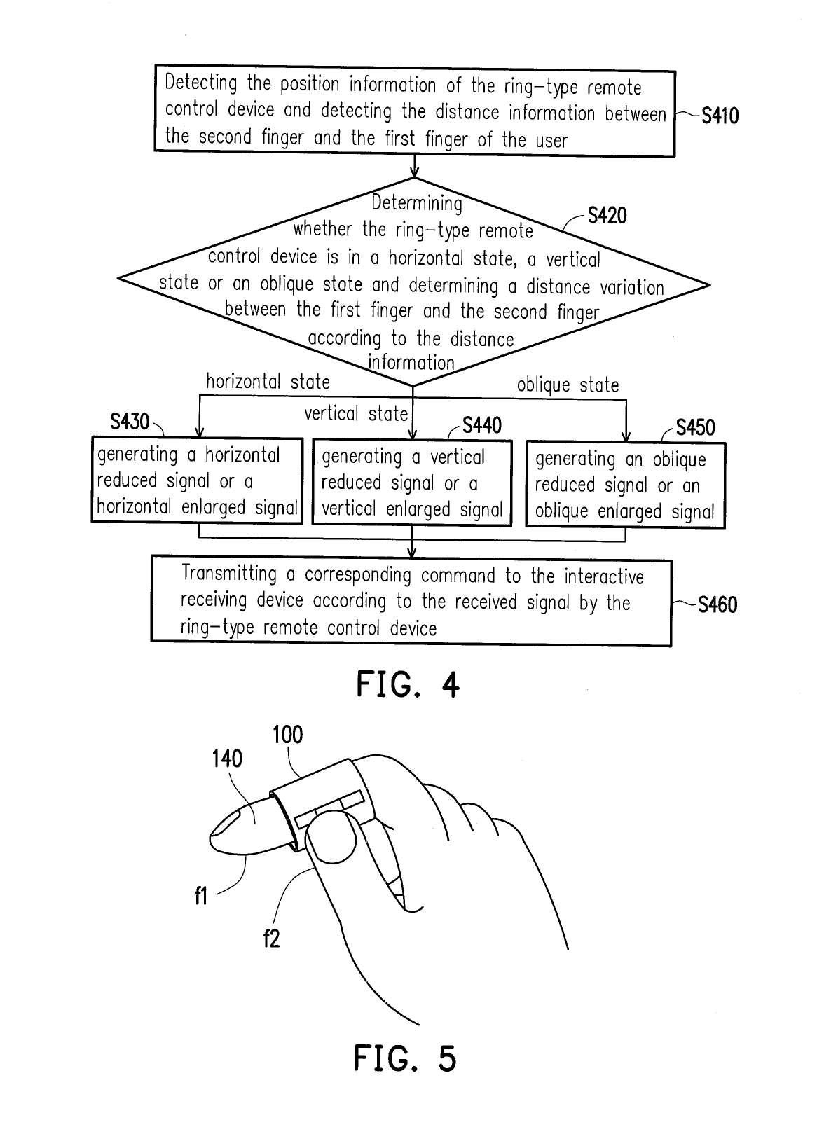

FIG. 4 is a flow chart of another scaling control method according to an embodiment of the invention. Please refer to FIGS. 1 and 4 for the following description.

First, the motion sensor module 130 detects the position information of the ring-type remote control device 100, and then the first proximity sensor 140 detects the distance information between the second finger and the first finger of the user (Step S410). Then, the processing unit 110 determines whether the ring-type remote control device 100 is in a horizontal state, a vertical state or an oblique state and determines a distance variation between the first finger and the second finger according to the distance information.

If the ring-type remote control device 100 is in the horizontal state, Step S430 is subsequently performed, and it is decided whether a horizontal reduced signal or a horizontal enlarged signal is to be generated according to the distance variation between the first finger and the second finger. If the ring-type remote control device 100 is in the vertical state, Step S440 is subsequently performed, and it is decided whether a vertical reduced signal or a vertical enlarged signal is to be generated according to the distance variation between the first finger and the second finger. If the ring-type remote control device 100 is in the oblique state, Step S450 is subsequently performed, and it is decided whether an oblique reduced signal or an oblique enlarged signal is to be generated according to the distance variation between the first finger and the second finger. Then, the ring-type remote control device 100 transmits a corresponding reduced command or a corresponding enlarged command to the interactive receiving device according to the received reduced or enlarged signal (Step S460).

It should be noted that the present embodiment may further pre-set a predetermined angle. When the motion sensor module 130 determines that an oblique angle of the ring-type remote control device 100 is greater than the predetermined angle, the processing unit 110 issues an enlarged command or a reduced command along the upper-right to the lower-left diagonal. If the oblique angle of the ring-type remote control device 100 is less than or equal to the predetermined angle, the processing unit 110 issues an enlarged command or a reduced command along the upper-left to the lower-right diagonal. The predetermined angle may also be pre-set by the user according to actual application circumstances.

In other embodiments, the ring-type remote control device 100 shown in FIG. 1 may further generate different control signals combined with settings of other conditions. For example, when the first proximity sensor 140 detects the distance between the first finger and the second finger remains at a fixed value for more than a predetermined period of time, the processing unit 110 further generates a first control signal to the wireless communication module 120. Please refer to the description below.

FIG. 5 is a schematic diagram of an application scenario of a ring-type remote control device according to an embodiment of the invention. Referring to FIG. 5, it is presumed that the thumb f2 of the user contacts a side of the ring-type remote control device 100 for a certain period of time (such as 2 seconds), and the first proximity sensor 140 detects that the distance between the first finger and the second finger does not change for more than a predetermined period of time. Therefore, the processing unit 110 generates, for example, a first control signal to the wireless communication module 120. The first control signal is, for example, a tap signal. The wireless communication module 120 transmits a tap command corresponding to the tap signal to the interactive receiving device so as to control the interactive receiving device to select a corresponding object.

Furthermore, if the distance between the index finger f1 and the thumb f2 does not change for a certain period of time, but the motion sensor module 130 detects that the ring-type remote control device 100 keeps moving, then the processing unit 110 generates, for example, a second control signal to the wireless communication module 120. The second control signal is, for example, a drag signal. The wireless communication module 120 transmits a drag command corresponding to the drag signal to the interactive receiving device so as to control the interactive receiving device to move the selected object along a movement direction of the ring-type remote control device 100.

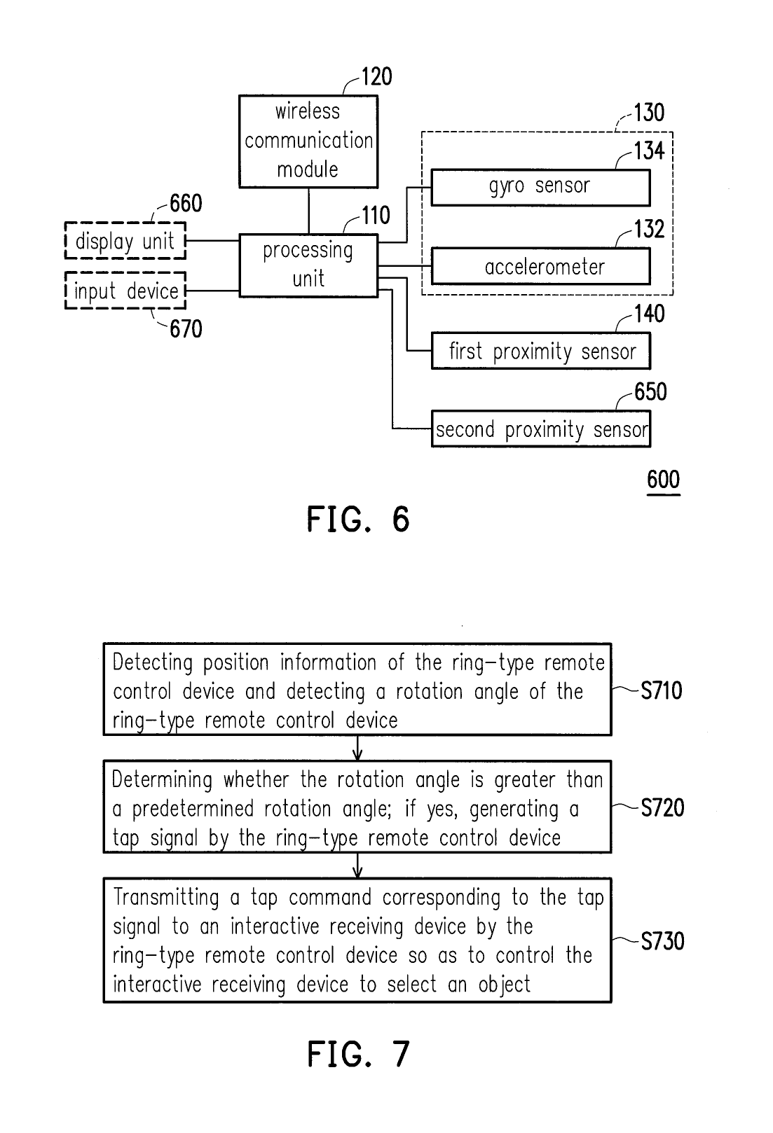

Another embodiment is described below as an example to prove that the invention can actually be realized. FIG. 6 is a block diagram of a ring-type remote control device according to another embodiment of the invention. Referring to FIG. 6, a ring-type remote control device 600 shown in FIG. 6 differs from FIG. 1 in that the ring-type remote control device 600 further includes a second proximity sensor 650, a display unit 660 and an input device 670. A structure of the second proximity sensor 650 is identical or similar to the structure of the first proximity sensor 140 and is not described in detail herein. The display unit 660 is, for example, an electronic paper display and assists in reminding the user of a correct gesture operation. The input device 670 is, for example, one or a plurality of physical keys and allows the user to generate a trigger signal by pressing the physical key.

In an embodiment of the invention, the user may control enables and disables of the first proximity sensor 140 and the second proximity sensor 650 through, for example, the physical key so as to generate different states accordingly.

In detail, when the first proximity sensor 140 and the second proximity sensor 650 are both enabled, the ring-type remote control device 600 is indicated to be in a first state. In the first state, the first proximity sensor 140 detects, for example, a distance variation between the index finger and the thumb of the user, and the second proximity sensor 650 detects, for example, a distance variation between the index finger and the middle finger of the user. With the position information detected by the motion sensor module 130, the processing unit 110 may generate different control signals such as enlarged, reduced, drag and tap signals accordingly.

When the first proximity sensor 140 is enabled and the second proximity sensor 650 is disabled, the ring-type remote control device 600 is indicated to be in a second state. When the first proximity sensor 140 is disabled and the second proximity sensor 650 is enabled, the ring-type remote control device 600 is indicated to be in a third state. Different state control signals are respectively generated corresponding to different states, and operation commands to which the state control signals correspond may be used and set by the user himself/herself.

FIG. 7 is a flow chart of a tap control method according to another embodiment of the invention. A method of the present embodiment is applicable for the ring-type remote control device 600 of FIG. 6. Detailed steps of the method of the present embodiment are elaborated below with reference to each element of the ring-type remote control device 600.

The motion sensor module 130 detects position information of the ring-type remote control device 600, and the gyro sensor 134 detects a rotation angle at which the ring-type remote control device 600 rotates around a fixed point (Step S710). Then, the processing unit 110 determines whether the rotation angle is greater than a predetermined rotation angle; if yes, the processing unit 110 generates a tap signal to the wireless communication module 120 (Step S720). The wireless communication module 120 of the ring-type remote control device 600 transmits a tap command corresponding to the tap signal to an interactive receiving device so as to control the interactive receiving device to select an object (Step S730). After the selected object is confirmed, the user may further enlarge or reduce the selected object through an operation of the distance variation between the fingers correspondingly.

It should be noted that in Step S720, the processing unit 110 may further determine whether the ring-type remote control device 600 rotates clockwise or counter-clockwise according to the rotation angle detected by the motion sensor module 130. When the ring-type remote control device 600 rotates clockwise, the processing unit 110 may generate a first control signal correspondingly. When the ring-type remote control device 600 rotates counter-clockwise, the processing unit 110 may generate a second control signal correspondingly. In the present embodiment, commands to which the first and the second control signals respectively correspond may be set by the user himself/herself. For example, the first control signal represents a control command of “Yes,” and the second control signal represents a control command of “No.”

The control method in the invention which uses a ring-type remote control device to perform interactive operations is not limited to the above descriptions. Persons of ordinary skill in the art may generate different control commands according to actual application needs. In other words, the spirit of the invention lies in using the ring-type remote control device of the invention to control an object in an interactive receiving device, wherein the ring-type remote control device includes a motion sensor module and a proximity sensor to detect a distance variation between fingers.

In summary of the above, through the use of the motion sensor module and the proximity sensor, the ring-type remote control device and the control method thereof in the invention allow the user to control the object in the interactive receiving device intuitively and quickly by wearing the ring-type remote control device.

Although the invention has been disclosed by the above embodiments, they are not intended to limit the invention. It will be apparent to persons of ordinary skill in the art that modifications and variations to the invention may be made without departing from the spirit and the scope of the invention. Accordingly, the protection scope of the invention falls in the appended claims.

What is claimed is:

1. A ring-type remote control device, adapted to be disposed surrounding a first finger of a user, the ring-type remote control device comprising:
a processing unit;
a wireless communication module coupled to the processing unit;
a motion sensor module coupled to the processing unit, detecting position information of the ring-type remote control device; and
a first proximity sensor coupled to the processing unit, detecting distance information between a second finger and the first finger of the user,
wherein when the processing unit determines a distance between the first finger and the second finger decreases according to the position information and the distance information, the processing unit generates a reduced signal to the wireless communication module, and when the processing unit determines the distance between the first finger and the second finger increases, the processing unit generates an enlarged signal to the wireless communication module, wherein the wireless communication module transmits a command corresponding to the reduced signal or the enlarged signal to an interactive receiving device.

2. The ring-type remote control device according to claim 1, wherein
the motion sensor module comprises an accelerometer and a gyro sensor, the accelerometer detects an acceleration of the ring-type remote control device, the gyro sensor detects an angular velocity of the ring-type remote control device, and
the motion sensor module generates the position information according to the detected acceleration and the detected angular velocity.

3. The ring-type remote control device according to claim 1, wherein
the processing unit determines whether the ring-type remote control device is in a horizontal state, a vertical state or an oblique state according to the position information, when the ring-type remote control device is in the horizontal state, the processing unit decides whether to generate a horizontal reduced signal or a horizontal enlarged signal according to the distance information, when the ring-type remote control device is in the vertical state, the processing unit decides whether to generate a vertical reduced signal or a vertical enlarged signal according to the distance information, and when the ring-type remote control device is in the oblique state, the processing unit decides whether to generate an oblique reduced signal or an oblique enlarged signal according to the distance information.

4. The ring-type remote control device according to claim 1, wherein when the processing unit determines a time for which the distance between the first finger and the second finger remains at a fixed value exceeds a predetermined period of time according to the distance information, the processing unit further generates a first control signal to the wireless communication module.

5. The ring-type remote control device according to claim 1, wherein when the processing unit determines according to the distance information that the distance between the first finger and the second finger remains at a fixed value, and that the ring-type remote control device keeps moving, the processing unit further generates a second control signal to the wireless communication module.

6. The ring-type remote control device according to claim 1, further comprising:
a second proximity sensor coupled to the processing unit,
wherein the processing unit generates a first, a second and a third states by controlling enables and disables of the first and the second proximity sensors, and the processing unit generates corresponding a state control signal corresponding to each of the states respectively.

7. A scaling control method for a ring-type remote control device, wherein the ring-type remote control device is disposed surrounding a first finger of a user, the scaling control method comprising:
detecting position information of the ring-type remote control device, and then detecting distance information between a second finger and the first finger of the user;
determining a distance variation between the first finger and the second finger according to the position information and the distance information;
generating a reduced signal by the ring-type remote control device when the distance between the first finger and the second finger decreases, and generating an enlarged signal by the ring-type remote control device when the distance between the first finger and the second finger increases; and
transmitting to an interactive receiving device a reduced command or an enlarged command corresponding to the reduced signal or the enlarged signal by the ring-type remote control device so as to control the interactive receiving device to reduce or enlarge an object correspondingly.

8. The scaling control method according to claim 7, wherein the step of detecting the position information of the ring-type remote control device comprises:
detecting an acceleration of the ring-type remote control device by an accelerometer, and detecting an angular velocity of the ring-type remote control device by a gyro sensor; and
generating the position information according to the acceleration and the angular velocity.

9. The scaling control method according to claim 7, further comprising:
determining whether the ring-type remote control device is in a horizontal state, a vertical state or an oblique state according to the position information; and
deciding to generate a horizontal reduced signal or a horizontal enlarged signal according to the distance information when the ring-type remote control device is in the horizontal state, deciding to generate a vertical reduced signal or a vertical enlarged signal according to the distance information when the ring-type remote control device is in the vertical state, and deciding to generate an oblique reduced signal or an oblique enlarged signal according to the distance information when the ring-type remote control device is in the oblique state.

10. The scaling control method according to claim 7, further comprising:
determining whether a distance between the first finger and the second finger remains at a fixed value according to the distance information;
determining whether a time for which the distance remains at the fixed value exceeds a predetermined period of time when the distance remains at the fixed value; and
generating a first control signal by the ring-type remote control device when the time for which the distance remains at the fixed value exceeds the predetermined period of time.

11. The scaling control method according to claim 7, further comprising:
determining whether a distance between the first finger and the second finger remains at a fixed value according to the distance information;
determining whether the ring-type remote control device keeps moving when the distance remains at the fixed value; and
generating a second control signal by the ring-type remote control device when the ring-type remote control device keeps moving.

12. The scaling control method according to claim 7, further comprising:
determining whether the ring-type remote control device has a first and a second proximity sensors;
determining a present state of the ring-type remote control device according to enables and disables of the first and the second proximity sensors when the ring-type remote control device has the first and the second proximity sensors; and
generating a state control signal corresponding to the present state.

13. A tap control method for a ring-type remote control device, wherein the ring-type remote control device is disposed surrounding a finger of a user, the tap control method comprising:
detecting position information of the ring-type remote control device, and detecting a rotation angle of the ring-type remote control device;
determining whether the rotation angle is greater than a predetermined rotation angle, and generating a tap signal by the ring-type remote control device if the rotation angle is greater than the predetermined rotation angle; and
transmitting a tap command corresponding to the tap signal to an interactive receiving device by the ring-type remote control device so as to control the interactive receiving device to select an object.

14. The tap control method according to claim 13, wherein the step of detecting the position information of the ring-type remote control device comprises:
detecting an acceleration of the ring-type remote control device by an accelerometer, and detecting an angular velocity of the ring-type remote control device by a gyro sensor; and
generating the position information according to the acceleration and the angular velocity.

15. The tap control method according to claim 13, further comprising:
determining whether the ring-type remote control device rotates clockwise or counter-clockwise according to the rotation angle; and
controlling the ring-type remote control device to generate a first control signal when the ring-type remote control device rotates clockwise, and controlling the ring-type remote control device to generate a second control signal when the ring-type remote control device rotates counter-clockwise.
